(19) United States
(12) Patent Application Publication
(10) Pub. No.: US 2011/0192242 A1
(43) Pub. Date: Aug. 11, 2011

(54) LEVERAGE MOTOR

(76) Inventor: Hans Werner Bierganns, Bergisch Gladbach (DE)

(21) Appl. No.: 12/998,443

(22) PCT Filed: Oct. 23, 2009
(86) PCT No.: PCT/EP2009/007603

§ 371 Date: Apr. 21, 2011

(30) Foreign Application Priority Data
Oct. 23, 2008 (DE) 10 2008 053 209.6

(51) Int. Cl. F16H 21/40

(52) U.S. Cl. 74/25

(57) ABSTRACT

Disclosed is a leverage motor (1) comprising at least two levers (6), at least one shaft (8, 29), and at least one auxiliary drive unit (2). Said leverage motor (1) further comprises at least one element (4, 5) which can be driven by the auxiliary drive unit (2), is arranged approximately perpendicular to the shaft (8, 29), and is rotatably mounted on the shaft (8, 29). The at least two levers (6, 60, 61) are mounted on the shaft (8, 29) in a rotationally fixed manner and can be directly or indirectly driven by the element in a damped fashion.

### FIELD OF THE INVENTION

The invention relates to a leverage motor with at least two levers, at least one shaft and at least one auxiliary drive unit.

### BACKGROUND OF THE INVENTION

The use of leverage forces in drive arrangements is basically known. For example, DE 37 39 328 A1 discloses a weight motor, in which weights on a hub fastened to a shaft are displaceable radially by means of an auxiliary force. The displacing arrangement is controllable such that between the one side of a vertical passing through the rotation axis and the other side, a weight or respectively lever arm difference exists. The displacement path of the displacing arrangement is equal to or greater than the distance between the maximum radial outer position of the weights and the rotation axis, so that the weights can be displaced such that they always produce a positive rotation force.

A further weight motor is known for example from DE 37 33 366 A1. In this, weights can likewise be displaced radially by means of an auxiliary force, whereby by altering the lever arm a rotation force is produced. Here, on the vertical passing through the rotation axis, on which the weights have a small lever arm, there is a cam track, the distance of which from the rotation axis on the lower quadrant decreases by the difference of the lever arms. In addition, the cam track can be embodied as a ring which is arranged staggered with respect to the rotation axis of the motor.

A further weight motor is known from DE 10 2004 035 290 A1. Here, also, weights are again mounted so as to be radially displaceable, wherein the lateral displacement of the weights is determined by a cam track which lies in a plane perpendicularly to the shaft axis and staggered with respect thereto. Here, also, the displacement of individual weights takes place towards the exterior by engagement of an auxiliary force. The weights situated radially opposite are connected with each other, so that they carry out the radial displacement together. They engage eccentrically on the shaft via a lever and a spring element. In addition to or instead of the lever of the spring element, it is disclosed that the weights are fastened on a ring which is displaceable eccentrically relative to the shaft and co-rotates therewith. In addition, instead of via lever and energy store of the lever, the application of force can also take place via a piston/cylinder unit and a lever fastened eccentrically on the hub. The radially opposite weights engage on the shaft via a piston/cylinder unit, which is constructed as an element applying compressive force, and a double lever fastened eccentrically on the hub. The piston/cylinder unit is securely connected with the weights and rests in the upper half of the circle on the lever, so that a rotational force is produced both by the weight in the ring and also via the lever. By the lifting of the upper weight, the opposite weight is also lifted via a lifting cable, wherein the lifting cable runs, guided by rollers, over the opposite weight and is fastened by its ends on the weight and on the free end of the lever. It is achieved hereby that the lower weight which is lifted by the lever cable half-way on the lever produces a rotational force. On the side associated with the cam track, the weights are provided with support rollers, by which they rest in the upper half of the circle on the concurrently-running ring-shaped cam track. The cam track can, in addition, be rotatably mounted on its own shaft and is driven by the support rollers which are pressed on in the upper half of the circle. With a cam track running concurrently, a separately mounted centrifugal mass is securely connected with the cam track. One weight respectively of the weights which are connected with each other is connected via a lever linkage eccentrically with the hub, with the lever linkage additionally having a spring element. When the weights, which are connected with each other, are situated in the vertical, the upper weight exerts a torque on the shaft through the lever linkage, in order to assist the rotation.

A motor using leverage force is known in addition from DE 1 576 043 A1. This is based on a two-stroke, two-cylinder or internal combustion engine. A rigid combination is provided of two pistons in opposite combustion cylinders with two pistons running parallel in fuel mixture supply cylinders. A power transmission takes place by means of a bolt which is arranged in the centre of the rigid combination and engages by its lower end by means of a ball into a groove guideway, which runs in the sense of the movements of the piston which have occurred through the combustion process obliquely over the curvature of a roller and causes this to rotate.

### SUMMARY OF THE INVENTION

The present invention is based on the problem of providing a motor using leverage, which is able to operate without additional weights, so that fewer moved masses nevertheless lead to a higher efficiency of the motor.

The problem is solved by a leverage motor with at least one shaft and at least one auxiliary drive unit, in that at least one element is provided, able to be driven by the auxiliary drive unit, arranged approximately perpendicularly to the shaft and mounted rotatably on the latter, and the at least two levers are mounted in a rotationally fixed manner on the shaft and can be directly or indirectly driven by the element in a buffered manner. Further developments of the invention are defined in the dependent claims.

A leverage motor is thereby created, in which no additional weights have to be displaced. Rather, by the provision of the at least two levers which are mounted in a rotationally fixed manner on the shaft, co-rotating therewith, the production of a torque takes place around the shaft, assisting its rotation. The rotation of the shaft is initiated here by the auxiliary drive unit. Hereby, with the movement of the element owing to the possibility of driving the levers, the lever is deflected at least at its end remote from the shaft, and hereby a torque is exerted onto the shaft. In particular, the lever can even be slightly deflected in the region of its fastening on the shaft, wherein the rotary process is assisted owing to the lever length. With an increasing rotation speed, the auxiliary drive unit is relieved, because the individual levers as centrifugal bodies as a result of the centrifugal force lead to an increasing relief for this auxiliary drive unit. Here, respectively, an at least momentary imbalance is utilized, in order to produce a corresponding torque, which is exerted directly onto the shaft owing to the mounting of the levers in or on the shaft. The centrifugal forces are therefore utilized in order to build up a torque, which finally leads to a greater power output than supply of power being possible. Depending on the choice of length of the levers, which are in particular lever rods, a variable transmission of force is possible, the longer the lever rods therefore are, the higher the possible transmission of force onto the shaft. Owing to the provision of a buffering for the start-up of the leverage motor, a quiet start-up is possible, substantially without a jerky movement of the lever. Such a buffering can take place in particular with the provision of at least one spring element.

The element can be constructed as a disc element, in particular as a star-shaped disc element. Hereby, a smaller mass is moved than with the provision of a disc having a full surface. Basically, a delicate structure in the form e.g. of a linkage could also be provided here, in order to save further weight. However, the element also serves as a centrifugal mass, so that the provision of a sufficient mass of the element also proves to be advantageous in this respect. With the provision of a drive with higher speeds, such as a turbine drive, a construction of the element with only a small mass is suitable, however, so that in particular in this variant embodiment a linkage can advantageously be used.

The auxiliary drive unit engages on the disc element, so that the disc element rotates with respect to the shaft. A bearing of the disc element on the shaft takes place for example by a ball bearing. On rotation of the disc element, the shaft is therefore not co-rotated at the same time, but rather a decoupling or respectively a transmission takes place from the auxiliary drive unit to the shaft via the disc element and the levers, which in turn are directly connected to the shaft. The disc element, or respectively the element which is rotatably mounted on the shaft and is driven by the auxiliary drive unit, and the levers are connected with each other here so that on rotation of the element, the levers are also entrained. At the end of the lever remote from the shaft, on the rotational movement owing to the entrainment of the levers by the disc element which takes place firstly, and the centrifugal forces which are then acting, a slight deflection can then take place, wherein the lever, in particular the lever rod, is mounted on the shaft. With the rotational movement or respectively the entrainment of the lever, a torque is produced through this slight deflection, which assists the rotational movement. This lever end is connected in particular via a spring element and/or a piston/cylinder unit with the element which is able to be driven by the auxiliary drive unit, in particular the disc element. The provision of a spring element and/or a piston/cylinder unit can be dispensed with, if in the region of the securing of the lever on the shaft at least one spring element, in particular a leaf spring, is provided. At least one of the levers can in addition be constructed itself as a spring element, in particular as a leaf spring. To connect the levers with the drivable element, a joint or a joint rod can be provided at the correspondingly remote end of the levers. By the connecting of the lever with the drivable element, in each of the said cases on starting-up and later with the rapid movement of the lever, a tractive force is exerted on the latter, wherein through the elastic connection in particular the starting-up movement is buffered, so that a smooth start-up is made possible. It can thereby be prevented that the levers drift in an uncontrolled manner, which possibly can lead not only to damage to the levers themselves, but also to a striking against further parts of the leverage motor and to a preventing of the formation of the desired torque, assisting the rotational movement.

Instead of the provision of at least one spring element, as already mentioned, a piston/cylinder unit or else only a joint rod can be provided. This has respectively, on the end side, joints which engage on the lever and indirectly or directly on the element, so that a tilting in the region of the joints is prevented and, at the same time, the element and lever are coupled to each other through the joint rod. On starting-up the motor, the levers can therefore be carried along in turn by the element which is driven by the auxiliary drive unit, wherein on the further movement and acceleration, owing to the articulated connection, the levers can also go ahead of the element and carry it along. At least owing to the lever length in each of the cases a great force or respectively a great torque can be transferred to the shaft.

Alternatively to the provision of a spring element or a piston/cylinder unit or respectively a traction cylinder, the lever can be mounted elastically via a cable arrangement. The latter engages in particular around a section of the periphery of the shaft, is securely mounted at a location on the shaft and engages by its other end on the end of the lever outside the shaft. At least in this region, the lever can be constructed elastically, in particular as a leaf spring or can be connected with a spring element which is fastened to the shaft. The lever is thereby itself a spring leaf and is prestressed by the cable arrangement or respectively the cable arrangement also prestresses the leaf spring. An elastic connection to the element which is driven by the auxiliary drive unit, in particular the disc element, can therefore be dispensed with. In this region, however, an adjusting arrangement can be provided for adjusting the initial position of the lever and hence also of the leaf spring. The tensile stress exerted by the cable arrangement can be regulated by the provision of an adjusting arrangement, such as a setscrew, and can be adjusted to the desired value. Instead of the provision of only one leaf spring, several may also be provided, layered one over another as a spring set, in order to intensify the tensile force on the cable arrangement. The choice of the length and number of the leaf spring(s) can be made depending on the intended purpose of the motor.

Further advantageously, the levers have, on their end side, support elements which are arranged so as to be staggered with respect to each other, which are arranged inside and outside the hollow shaft so that the levers are retained against dipping into the shaft, and an entrainment of the shaft by the levers is guaranteed. A slight deflection with respect to the shaft can be permitted in a small, presettable angle. By the support elements, which hold the lever, on the one hand outside and on the other hand inside the hollow shaft, against the latter, co-rotating with the latter, a simple solution is created for preventing a complete dipping of the levers into the shaft, likewise a means against a complete withdrawing of the levers out of the shaft, because the lever is also held on the inner side of the hollow shaft and therefore centrifugal forces in this direction are counteracted. A movement of the lever therefore on the action of centrifugal forces can therefore only take place elastically in a permitted deflection over the longitudinal extent of the lever, in the permitted deflection angle, so that a torque can build up about this bearing site in the shaft, depending on the length of the lever.

At the end lying opposite the bearing site in the shaft, the lever can advantageously be provided with a spherical or hemispherical element to form a joint, for cooperation with a corresponding counter-piece, e.g. the joint rod which has already been mentioned. Spherical or hemispherical elements can roll in the counter-piece with the moving of the levers and hence of the joint rod on the rotational movement and the change of position taking place of the levers with respect to their initial position.

The end of the levers lying opposite the bearing site in the shaft can be additionally constructed in the manner of a blade or in the manner of a turbine wheel, and/or the lever itself can be constructed in the manner of a turbine blade or windmill blade or provided at least on the end side with correspondingly shaped elements.

Further advantageously, the levers are constructed as lever rods and are arranged staggered with respect to each other along the longitudinal extent of the shaft. In addition, it is possible to provide two star-shaped disc elements and to arrange the levers, constructed as lever rods, staggered to the disc elements which are constructed in a star shape. The two star-shaped disc elements are advantageously connected with each other in the region of their projecting ends by at least one connecting element, in particular a rod element. A particularly stable connection is produced by the provision of several such connecting-, in particular rod elements, which connect the two end-side disc elements of the leverage motor with each other in a stable manner. The spring element and/or piston/cylinder unit or respectively pressure cylinder and/or joint rods can engage on the rod element or can be connectable or connected therewith. This is suitable namely with the provision of several levers arranged staggered with respect to each other along the longitudinal extent of the shaft. Basically, the provision of dish-shaped connecting elements, which overlap a circular segment region, or even a tube-shaped connecting element would also be possible, which connects the star-shaped or otherwise shaped elements, in particular disc elements, with each other.

For example, not only two, but six to eight levers, in particular lever rods, can be provided with correspondingly six to eight projecting ends of star-shaped disc elements. Here, the levers or lever rods are respectively arranged between the projecting ends of the star-shaped disc elements, therefore staggered with respect thereto.

The leverage motor can be combined with other motors and/or in series, in particular incorporated in front of other motors into an arrangement, or respectively provided therein. An auxiliary drive unit can be formed in particular by water turbines or another type of drive using alternative energies.

In addition, it is possible to achieve an acceleration or respectively adjustment of the rotational speed by provision of a gear unit, arranged upstream of the leverage motor, which is adjustable in particular so that an adaptation to respective cases of load is possible without difficulty.

### BRIEF DESCRIPTION OF THE DRAWINGS

For a further explanation of the invention, embodiments thereof are described in further detail by means of the drawings, in which:

FIG. 1 shows a top view onto a first embodiment of a leverage motor according to the invention,

FIG. 2 a side view of the leverage motor according to FIG. 1,

FIG. 3 a detail sectional view of a lever of the leverage motor according to FIG. 1,

FIG. 4 a detail sectional view of the shaft and of a lever of the leverage motor according to FIG. 1,

FIG. 5 a sectional view of the detail of a shaft and of a lever of a leverage motor according to the invention in a second embodiment,

FIG. 6 a partial sectional view of a solid shaft with lever for a leverage motor according to the invention in a third embodiment, and

FIG. 7 a side view of a further embodiment of a leverage motor according to the invention.

### DETAILED DESCRIPTION OF THE INVENTION

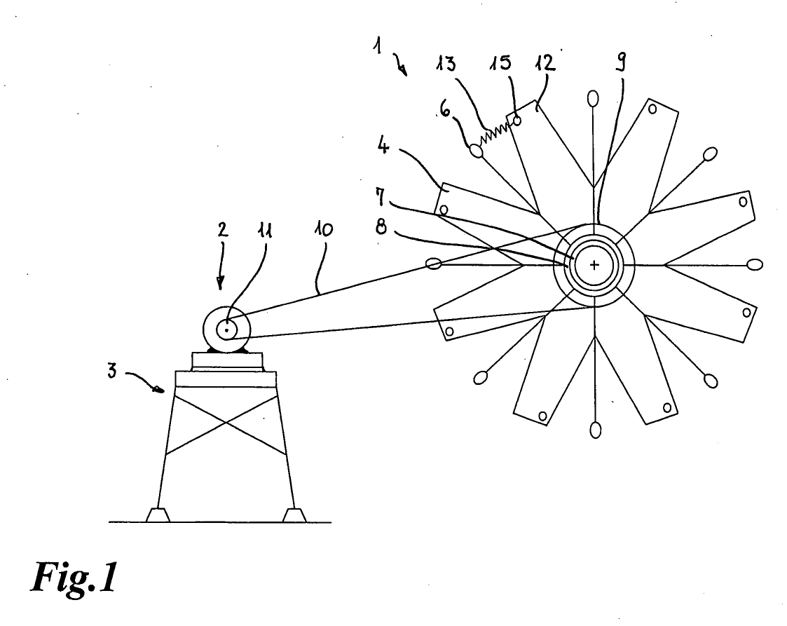

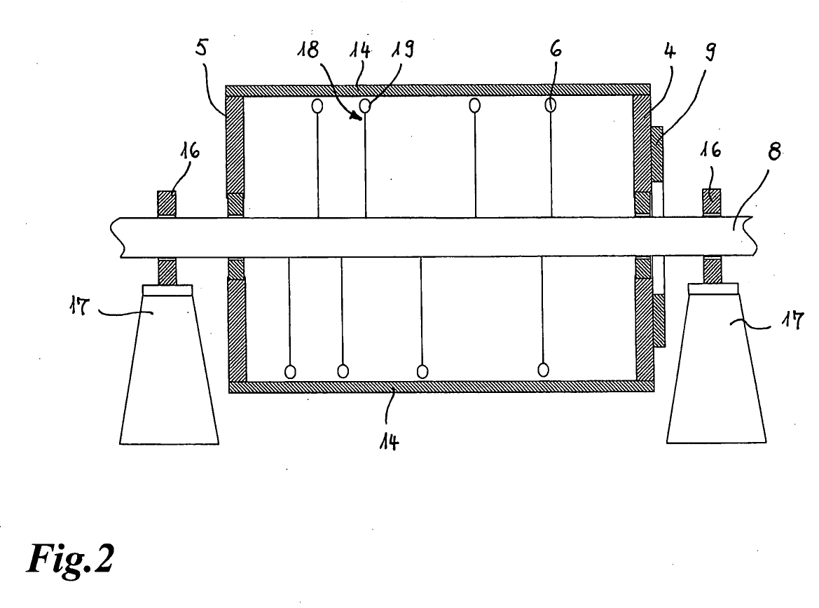

FIG. 1 shows a schematic diagram of a leverage motor 1 with an auxiliary drive unit 2. The auxiliary drive unit is constructed as an electric motor and rests on a support arrangement 3. The leverage motor has in addition two star-shaped disc elements 4, 5 with eight blunt teeth on the end side and eight lever rods 6. The star-shaped disc elements 4, 5 are mounted via ball bearings 7 on a shaft 8, which is constructed as a hollow shaft. The lever rods 6, on the other hand, are mounted directly in the shaft, as can be seen from FIG. 2.

On the one star-shaped disc element 4 a belt pulley 9 is arranged, which is connected via a drive belt 10 with an output pinion 11 of the auxiliary drive unit. The star-shaped disc element 4 can therefore be driven rotatably via this and subsequently rotates with respect to the shaft at a speed which is reduced accordingly owing to the different diameter of the output pinion 11 and of the belt pulley 9.

A spring element 13 in the form of a coil spring is arranged between the star-shaped disc element 4 and the lever rods 6 or respectively a lever rod 6, adjacent respectively to a section 12, projecting in tooth form, of the star-shaped disc element. Instead of the coil spring which is shown as spring element 13, in addition a pressure cylinder or a joint rod can be provided here. As can be seen better from the side view in FIG. 2, the spring element 13 is not fastened directly on this projecting section 12 of the star-shaped disc element 4, but preferably rather on a rod element 14, which extends between respective projecting sections 12 of the two star-shaped disc elements 4, 5 which arranged approximately parallel to each other. In FIG. 2 only two rod elements 14 are shown. In principle, these are already sufficient for a stable connection of the two star-shaped disc elements 4, 5. Usually, however, a number of rod elements corresponding to the number of the projecting sections 12 of the two star-shaped disc elements 4, 5 is arranged between them. For this purpose, openings 15 are provided here in the projecting sections 12, as can be seen better from FIG. 1. The rod elements 14 are guided through this opening and in particular are fastened securely therein. Another type of fastening is also possible, without the provision of openings in the disc elements. A fastening with or without the provision of openings in the disc elements can take place e.g. by welding. Basically, instead of rod elements, tube sections or respectively dish elements or even a tube can also be provided, which connect or connects the disc elements 4, 5 with each other.

As can be further seen from FIG. 2, the two star-shaped disc elements 4, 5 rest via ball bearings 7 on the shaft 8, which is constructed as a hollow shaft. The hollow shaft itself is held in further ball bearings 16 on support bearings 17. In the drawing, towards the right, lying outside of this and therefore not visible, the drive side is provided with the auxiliary drive unit 2, with the belt pulley 9 being arranged on the disc element 4. On the left-hand side, the output side of the shaft lies in the support bearing 17 there. A gear unit can be connected here, in order to be able to utilize the driving force for example for a vehicle, for its drive system, in particular for a passenger car. In such an arrangement, the leverage motor can be used in particular in a horizontal position. Basically, however, a perpendicular positioning is also possible, but the space requirement in this arrangement is greater than with the horizontal arrangement, so that the horizontal installation proves to be more suitable for use in a vehicle.

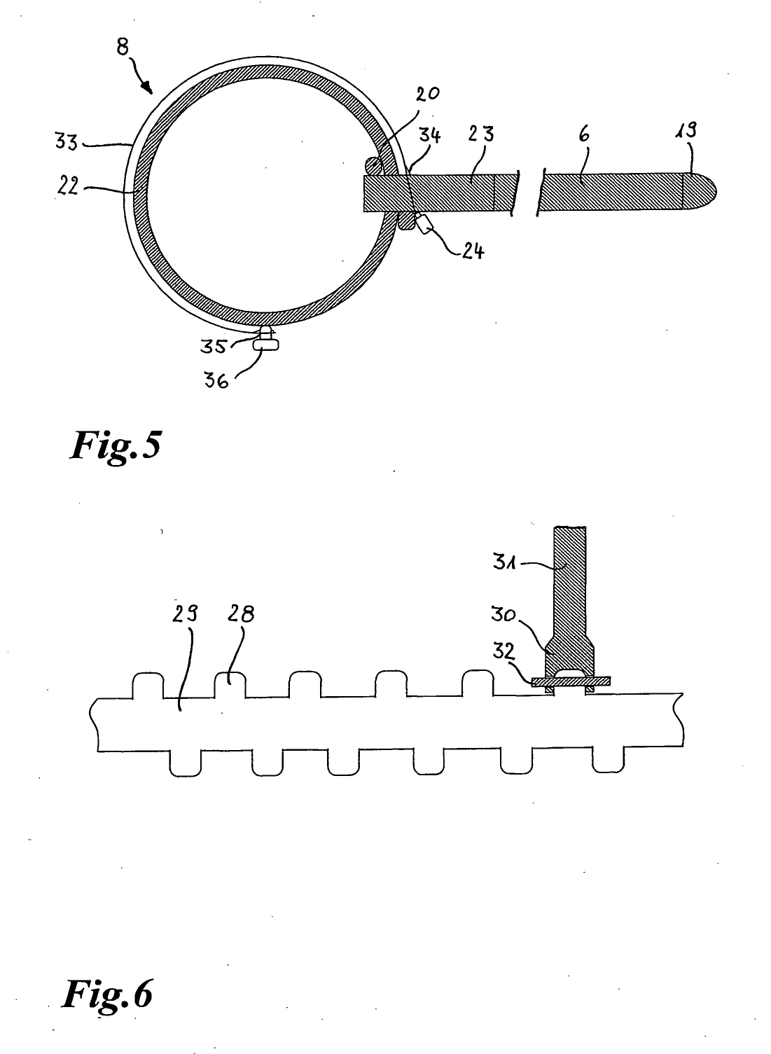

As can be further seen from FIG. 2, the lever rods 6 are also arranged staggered with respect to each other along the shaft 8, i.e. one behind the other along the shaft with different distances from each other, but not lying respectively in pairs opposite each other. The lever rods are additionally connected with the shaft in a co-rotating manner therewith, i.e. not via a ball bearing. A possibility for arranging the lever rods on the shaft can be seen from FIG. 4, and two further variants from FIGS. 5 and 6. These will be described in further detail below.

The lever rods 6 have respectively at their end 18, remote from the shaft 8, elements 19 which are rounded, in particular are constructed as hemispherical elements. The elements can engage in joint housings of a joint rod, which creates a connection to the rod elements 14. Such a joint rod is not shown, however, in FIG. 2; rather, the spring element 13 is provided. A rod element held by a screw, a bolt etc. can also be provided between lever rod 6 and rod element 14. In addition, with the provision of at least one leaf spring in the region of the securing of the lever rod on the shaft (see FIG. 5), only one joint can be provided, in particular a hemispherical joint, between lever rod and rod element 14. By an elastic or buffered connection e.g. by the provision of an oil cylinder or spring element, or by the provision of the said at least one leaf spring, a buffered and hence non-jerky start-up can be brought about.

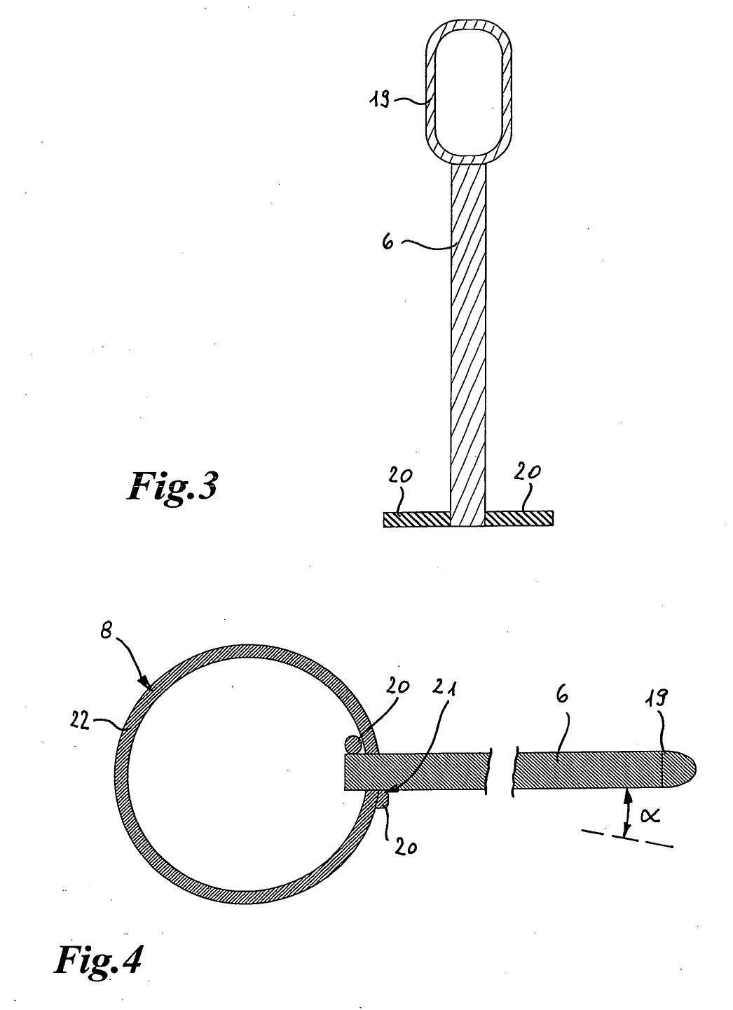

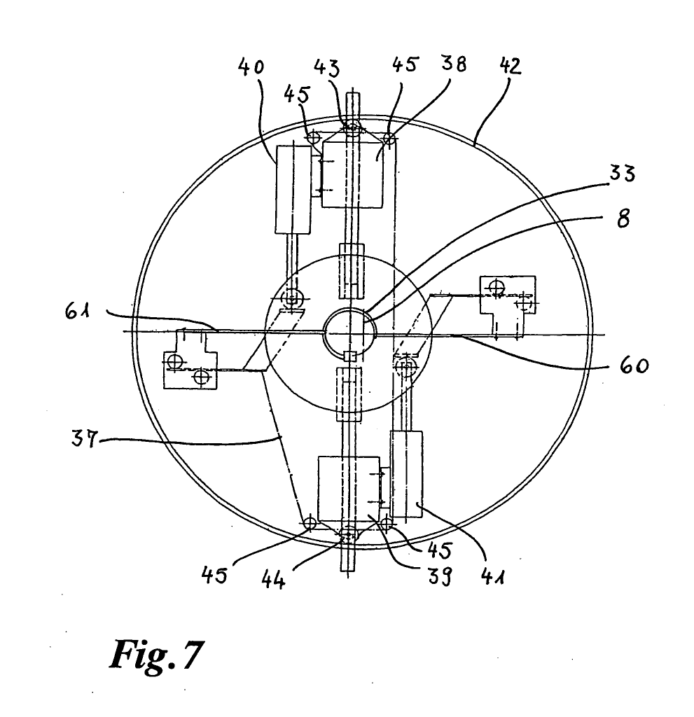

A lever rod 6 with a rounded element 19 and with a support element 20 on the end side is shown as a detail view in FIG. 3. The support element 20 on the end side is, however, usually constructed so that it sits partly inside the wall 22 of the shaft, which is constructed as a hollow shaft, and at the same time also on the outer side thereof, in order to make possible a particularly good hold on the shaft. This can be seen from the detail view of shaft and lever rod in FIG. 4. A portion of the support element lies here on the inner side of the hollow shaft and a portion on the outer side. The lever rod itself projects through an opening 21 in the wall 22 of the shaft. With the provision of a spring-elastic material for the lever rod or at least of a part thereof, basically a slight deflection is possible about an angle □, with a torque being able to be produced via the long lever of the lever rod 6 and therefore with the rotational movement of the shaft being able to be assisted or respectively accelerated. With the provision of a cable element 33, as shown in the embodiments according to FIGS. 5 and 7, the lever rod is deflected.

The two parts of the support element 20 are fastened on the lever rod, in particular are welded securely thereon. Basically, the lever rod can, however, also be constructed so as to be already projecting in this region, at least in its end region, which rests on the inner side of the wall 22 of the shaft 8.

Alternatively to the provision of support elements 20 for fastening the lever rods on a hollow shaft, projecting cams 28 can be constructed on a solid shaft in the form of the shaft 29, which are overlapped by correspondingly constructed end-side lever sections 30 of lever rods 31. Here, a fastening of the lever rod on the cam is provided via corresponding bolts 32, as can be seen from FIG. 6. In addition, any other desired construction of the shaft and the connection to the lever rod is possible, if the shaft is not constructed as a hollow shaft, but rather as a solid shaft. A deflecting of the lever rod in the case of a solid shaft is mostly not possible in the region of the mounting on the shaft, but rather over the overall length of the lever rod, wherein a cable element, as is shown in FIG. 5, can be provided for producing a spring effect.

According to FIG. 5, the lever rod 6 has again the support elements 20, which rest on the inner and outer side of the wall 22 of the shaft 8, which is constructed as a hollow shaft in contrast to the embodiment according to FIG. 6. The cable element 33, in particular in the form of a wire cable, extends additionally around approximately three quarters of the periphery of the shaft 8. This cable engages with an end-side loop 34 on the lever rod or respectively in the embodiment according to FIG. 5 a leaf spring 23 connected therewith and with another end-side loop 35 on a fastening element 36 which is fastened on the shaft 8 on its outer side. By a prestressing of the cable element 33 and of the lever rod with respect to the fastening element, the spring element 13 in the form of a coil spring can be dispensed with, because the lever rod is held elastically under prestressing via the cable element 33. As is also indicated in FIG. 5, a setscrew 24 is provided for adjusting the tension of the cable element 33 in the region of the shaft. The lever rod 6 and the leaf spring 23 can be fastened on each other or joined. It is also possible to construct the entire lever rod as a leaf spring. A possibility for adjustment in the form e.g. of a setscrew can also be provided in the region of the rod elements 14 for adjusting the force acting on the lever rod or respectively on the leaf spring. In addition, the leaf spring can be multi-layered, in order to achieve a greater rigidity and therefore a reinforcing of the tensile stress which is exerted onto the wire cable.

The star-shaped disc element 4 is firstly driven by the auxiliary drive unit 2 in the form of the electric motor. The lever rods are entrained accordingly and thereby rotate the respective shaft on which they are fastened. The individual lever rods are to be regarded as centrifugal bodies which, as a result of the centrifugal force and the momentary imbalance occurring thereby, produce a torque which is exerted onto the shaft. Hereby, the latter is rotated and increasingly the electric motor is relieved, because the lever rods assist the rotational movement of the shaft. Owing to the utilization of the centrifugal forces and of the torque which is building up accordingly due to the imbalance occurring on the deflection of the lever rods with the rotational movement, it is possible to provide a greater power output than supply of power. For example, with the use of a weight force of 1 kg, 120 kg can be lifted or respectively moved with the provision of six levers. The length of the lever rods can be for example 50 to 60 cm here. Basically, of course, other lengths of the lever rods are also possible, with a greater torque being able to be achieved with longer lever rods and therefore also a greater power output. Shorter, rigid lever rods which are fastened to the shaft can be lengthened by for example elastically constructed lengthening elements, in order to achieve the desired spring effect on deflecting, or, vice versa, elastically-acting lever rods can be fastened on the shaft and lengthened by more rigid lengthening elements. An example of such a lever rod is shown in FIG. 7.

Here again the lever rod is constructed as a double lever rod 60 and is secured on the shaft 8. The cable element 33 engages on the lever rod 60, is guided around a partial region of the shaft 8 and is secured thereon. A second lever rod 61 is provided lying opposite the first lever rod 6, which can be moved via a lifting cable 37. The remaining structure of the motor is similar to the one described in DE 10 2004 035 290 A1.

Therefore in addition in FIG. 7, two weights 38, 39 are provided lying opposite each other, with two piston/cylinder units 40, 41 associated therewith. The piston/cylinder units 40, 41 are securely connected with the weights 38, 39. The piston-cylinder unit 41 rests on the lever rod 60, so that owing to the action of centrifugal forces with the rotational movement a rotational force is exerted onto an outer ring 42, just as on the lever rod 61 and the shaft. The weights 38, 39 rest via support rollers 43, 44 in the ring 42. On lifting of the upper weight 38 in the drawing, the opposite weight 39 is likewise lifted via the lifting cable 37, wherein the lifting cable 37 is secured on the one hand in the region of the weight 38 and on the other hand is guided via various rollers 45 and is secured in the region of the lever rod 61.

By the provision of the cable element 33, however, a direct coupling of the weights 38, 39 with the two lever rods 60, 61 can also take place, so that the lifting cable 37 can then be dispensed with.

In contrast to the prior art, in the present solution of a leverage motor, the lever rods therefore sit very much closer on the shaft, so that short transmissions are possible with, at the same time, lever rods of any desired length and therefore an adjustable extent of the possible power transmission.

Instead of the provision of an electric motor as auxiliary drive unit, renewable energies such as solar energy, wind energy and water power can also be used in order to bring the star-shaped disc elements and lever rods into operation, i.e. as initial energy. In addition, basically of course other energies can also be utilized as auxiliary energy.

Alongside the variant embodiments of leverage motors named above and shown in the drawings, numerous further ones are possible, in which respectively at least two levers are mounted on a shaft so as to be deflectable with respect thereto at least in a quite small angle, and held acted upon by a force counteracting centrifugal forces, wherein an auxiliary drive is used for initiating a rotational movement, which is reinforced due to the centrifugal forces acting on the levers and due to a torque which is building up. The at least two levers are mounted in a rotationally fixed manner on the shaft and can be driven by the auxiliary drive unit directly or indirectly in a buffered manner.

### LIST OF REFERENCE NUMBERS

1 leverage motor
2 auxiliary drive unit
3 support arrangement
4 star-shaped disc element
5 star-shaped disc element
6 lever rod
7 ball bearing
8 shaft
9 belt pulley
10 drive belt
11 output pinion
12 projecting section
13 spring element
14 rod element
15 opening
16 ball bearing
17 support bearing
18 end
19 element
20 support element
21 opening
22 wall
23 leaf spring
24 setscrew
28 cam
29 shaft
30 lever section
31 lever rod
32 bolt
33 cable element
34 loop
35 loop
36 fastening element
37 lifting cable
38 weight
39 weight
40 piston-cylinder unit
41 piston-cylinder unit
42 outer ring
43 support roller
44 support roller
45 roller
60 lever rod
61 lever rod
α deflection angle

What is claimed is:

1. A leverage motor, comprising: at least two levers, at least one shaft and at least one auxiliary drive unit,
wherein at least one element is provided, able to be driven by the auxiliary drive unit, arranged approximately perpendicular to the shaft, mounted rotatably on the latter, and the at least two levers are mounted in a rotationally fixed manner on the shaft and are able to be driven directly or indirectly by the element in a buffered manner.

2. The leverage motor according to claim 1, wherein the element is a disc element.

3. The leverage motor according to claim 2, wherein for buffered driving, the element and the at least two levers are connected with each other by one or more of a spring element, a piston-cylinder unit, and a joint rod.

4. The leverage motor according to claim 1, wherein at least one of the levers is mounted elastically via a cable arrangement.

5. The leverage motor according to claim 1, wherein the at least one shaft is hollow, wherein the levers have support elements, arranged staggered with respect to each other on the end side, which are arranged inside and outside the hollow shaft so that the levers are held against dipping into the shaft and a deflection of the levers with respect to the shaft is permitted.

6. The leverage motor according to claim 1, wherein the levers are provided on the end side with a spherical or hemispherical element for cooperating with or supporting on a joint surface, to form a joint.

7. The leverage motor according to claim 1, wherein at least one of the levers is connected with the shaft via at least one spring element.

8. The leverage motor according to claim 1, wherein at least one of the levers is constructed itself as a spring element.

9. The leverage motor according to claim 1, wherein the levers are constructed as lever rods and are arranged staggered with respect to each other along a longitudinal extent of the shaft.

10. The leverage motor according to claim 3, wherein two star-shaped disc elements are provided and the levers are constructed as lever rods and are arranged staggered with respect to the disc elements which are constructed in a star shape.

11. The leverage motor according to claim 1, wherein the star-shaped disc elements are connected with each other in the region of their projecting ends by at least one connecting element.

12. The leverage motor according to claim 11, wherein one or more of the spring element, piston/cylinder element, joint rod and joint arrangement engage on the connecting element that is a rod element or are connectable or connected therewith.

13. The leverage motor according to claim 3, wherein the joint rod has joints on the end side for articulated engaging on the rod element and the lever.

14. The leverage motor according to claim 2, wherein the disc element is a star-shaped disc element.

15. The leverage motor according to claim 7, wherein at least one spring element is a leaf spring.

16. The leverage motor according to claim 14, wherein the connecting element is a rod element.

17. The leverage motor according to claim 3, wherein at least one of the levers is mounted elastically via a cable arrangement.

18. The leverage motor according to claim 3, wherein the at least one shaft is hollow, wherein the levers have support elements, arranged staggered with respect to each other on the end side, which are arranged inside and outside the hollow shaft so that the levers are held against dipping into the shaft and a deflection of the levers with respect to the shaft is permitted.

19. The leverage motor according to claim 3, wherein the levers are provided on the end side with a spherical or hemispherical element for cooperating with or supporting on a joint surface, to form a joint.

20. The leverage motor according to claim 3, wherein at least one of the levers is connected with the shaft via at least one spring element.
